(19) United States
(12) Patent Application Publication
(10) Pub. No.: US 2014/0250957 A1
(43) Pub. Date: Sep. 11, 2014

(54) LOCK CYLINDER MOUNT FOR ROTARY ACTUATOR

(71) Applicant: Dale R. Krueger, Woodstock, IL (US)

(72) Inventor: Dale R. Krueger, Woodstock, IL (US)

(21) Appl. No.: 14/199,673

(22) Filed: Mar. 6, 2014

Related U.S. Application Data
(60) Provisional application No. 61/773,763, filed on Mar. 6, 2013.

(51) Int. Cl. E05B 47/00

(52) U.S. Cl. CPC E05B 47/0001
USPC 70/283.1

(57) ABSTRACT

A rotary lock actuator for manual or powered actuation of a lock of the type typically used on vehicle doors or storage compartments. The actuator has a housing with a motorized drive train therein. The housing is connected to a swage hub which is connected to a lock cylinder body by a cylindrical nut.

### CROSS-REFERENCE TO RELATED APPLICATION

This application claims the benefit of U.S. Provisional Application Ser. No. 61/773,763, filed on Mar. 6, 2013, the disclosure of which is incorporated herein in its entirety.

### BACKGROUND

The present subject matter generally relates to an actuator for manual or powered actuation of a locking device of the type having a lock cylinder body and a lock plug assembly.

Traditionally, locking devices have been operated and controlled manually by a key. Recently the use of powered or electromechanical systems to control locking devices has become common. The powered actuation of such of devices such as locks can be a great convenience and time saver for a user. For example, remote controlled or electromechanical door locks on automobile doors are widely used.

The present subject matter is directed to an actuator that provides for separate manual or powered control of the lock, thereby allowing manual actuation of the lock independently of the powered actuation. While powered actuators of this type are known, a common difficulty with prior art powered actuators is their incorporation in a standard mechanical locking device necessitates modification of the handle, latch, and/or surrounding frame structures to accommodate an electric motor and gear train. It would be preferable not to have to redesign a locking device and/or its associated structures in order to provide a powered actuator for the locking device. In other words, what is needed is a powered actuator that can be incorporated in existing mechanical locking devices without alteration of the mechanical locking device or its surrounding structures.

### SUMMARY

The present invention concerns an actuator assembly that can be added to a manual locking device of the type having a lock cylinder body and a locking member such as a lock rod or cam. The actuator assembly converts the manual locking device to one that can have manual or powered actuation. The actuator assembly is mounted on the lock cylinder body so that provision need not be made elsewhere for mounting the actuator. The actuator assembly includes a housing for enclosing a motor and a powered drive train engaged with the motor. The housing, motor and drive train may be similar to those shown in Krueger, U.S. Pat. No. 8,146,394, the disclosure of which is incorporated herein by reference in its entirety.

The housing includes a case and a cover as in the U.S. Pat. No. 8,146,394 patent. The cover is joined to a base plate and the base plate carries a mounting adaptor plate. The mounting adaptor plate is fixed to a swage hub. The swage hub surrounds a key lock adaptor shaft. A cylindrical nut is mounted for rotation on the swage hub. The nut has internal threads that are engageable with the external threads on the lock cylinder body. An external cam is mounted for rotation about the swage hub. The external cam is actuated by the drive pin of the actuator's output cam.

### BRIEF DESCRIPTION OF THE DRAWINGS

FIG. 1 is a right side elevation view of a locking device on which the actuator of the present invention can be mounted, with portions cut away and other parts shown transparently to reveal underlying structures.

FIG. 2 is a front elevation view of the actuator of the present invention mounted on the locking device of FIG. 1.

FIG. 3 is a top plan view of the actuator.

FIG. 4 is a perspective view of the lock cylinder body.

FIG. 5 is a perspective view of the nut.

FIG. 6 is a perspective view of the swage hub.

FIG. 7 is a front elevation view of the swage hub.

FIG. 8 is a left end elevation view of the swage hub.

FIG. 9 is a perspective view of the cam spacer ring.

FIG. 10 is right end elevation view of the cam spacer ring.

FIG. 11 is a perspective view of the external cam.

FIG. 12 is a right end elevation view of the external cam.

FIG. 13 is a front elevation view of the mounting adaptor plate.

FIG. 14 is left end elevation view of the mounting adaptor plate.

FIG. 15 is front elevation view of the base plate.

FIG. 16 is left end elevation view of the base plate.

FIG. 17 is a section taken along line 17-17 of FIG. 3 and including portions of the locking device.

### DETAILED DESCRIPTION

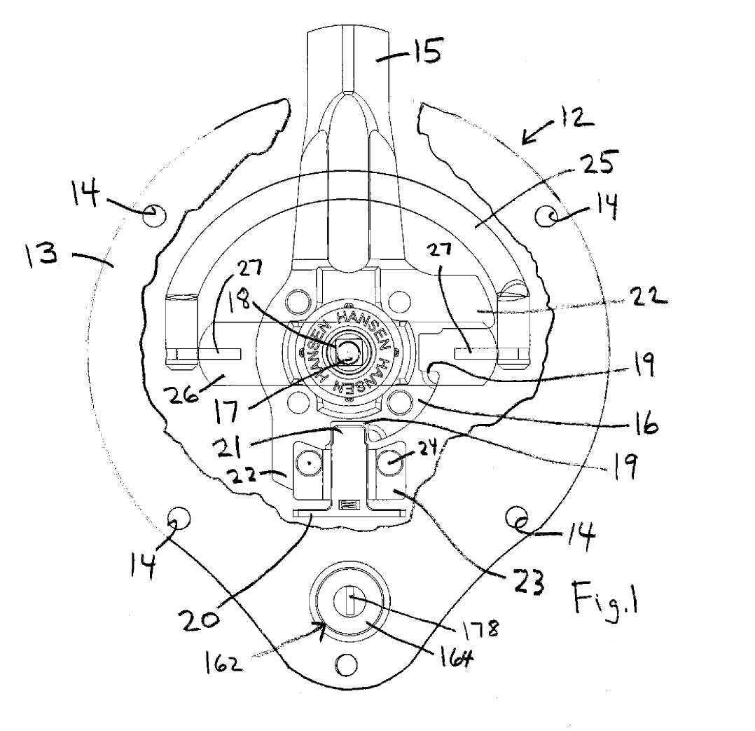

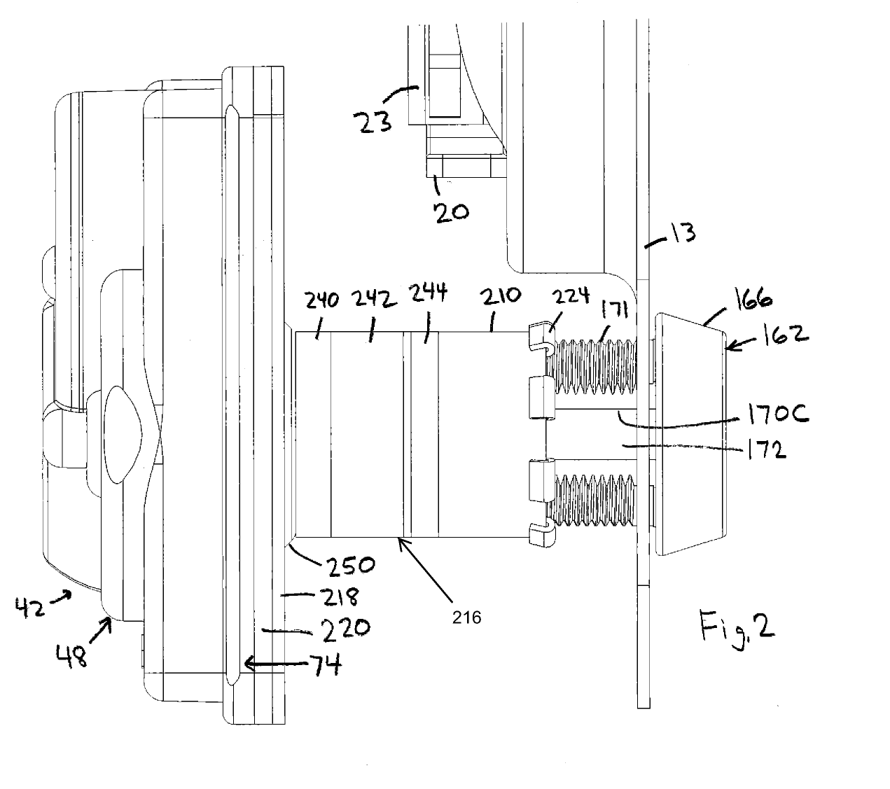

FIGS. 1 and 2 illustrate one embodiment of a handle and locking device to which the rotary lock actuator assembly 10 of the present invention can be added. The handle and locking device is shown generally at 12. It will be understood that the handle and locking device is incorporated in another structure (not shown), such as a vehicle door or a storage box door. One of the advantages of the actuator assembly 10 is that it can be incorporated in existing locking devices while requiring no modification of the door and no modification of the handle and lock mechanism. Thus, the handle and lock mechanism 12 is conventional. The particular locking device shown is described in Sadler, U.S. Pat. No. 6,666,053, the disclosure of which is incorporated herein by reference in its entirety. It will be understood that this particular locking device is for illustrative purposes only and the present invention could be incorporated in a wide variety of locking devices, none of which would have to be altered to accept the actuator assembly of the present invention.

The handle and lock mechanism 12 includes a tray 13 having optional tray holes 14 disposed about a surface of the tray 12. The tray holes 14 may be used to mount the tray 13 onto a door or other compartment.

The handle assembly 12 includes a latching arm 15 that is swung inside of a hole in a door jamb. Once inserted into such a hole, the door onto which the handle assembly 12 is attached cannot be opened. Additionally, latching arm 15 can be configured to prevent the door from opening by contacting a flange in a certain position or by its incorporation with other mechanisms. The latching arm 15 is connected to a lock cam 16. If lock cam 16 is prevented from moving, it necessarily follows that latching arm 15 is also prevented from moving due to its connection to lock cam 16. Lock cam 16 is connected to a shaft 17 by a nut 18. Shaft 17 rotates relative to tray 13, so lock cam 16 therefore can rotate relative to tray 13. As shown, lock cam 16 is provided with two lock slide openings 19.

A reversible spring-loaded lock slide 20 is configured to move into one of the lock slide openings 19. Once the lock slide 20 is inside, lock cam 16 is prevented from moving due to the contact with an end 21 of the lock slide 20. The lock cam 16 is provided with two stops 22 in order to allow for only 90 degrees of rotation of the lock cam 16.

Handle assembly 10 also includes a compression spring (not shown) that biases lock slide 20 in an unlocking direction. Both the spring and lock slide 20 are at least partially contained within spring-loaded slide case 23. Lock slide 20 is moveable relative to the spring-loaded slide case 23. Spring-loaded slide case 23 is attached to tray 13 via two rivets 24. The spring biases lock slide 20 into a position away from the lock cam 16. In such a fully biased position, lock slide 20 is completely removed from the lock slide openings 19 and hence lock cam 16 is free to rotate relative to tray 13, at least within the limits of stops 22. When the spring is compressed, lock slide 20 may move into one of the lock slide openings 19. Such a situation results in lockage of lock cam 16.

The handle 25 shown in FIG. 1 is a D-shaped handle having a section being angled away from the tray 13. A handle connection bar 26 is shown being used to attach handle 25 to the shaft 17. Handle 25 can be rotated about pins 27 away from tray 13 out of the compartment in tray 13 and then rotated about the shaft 17.

Since many of the components of the actuator assembly of the present invention are the same as or similar to corresponding components in the Krueger U.S. Pat. No. 8,146,394 patent, details of those components will not be described here. However, for convenient reference to Krueger U.S. Pat. No. 8,146,394, the reference numerals used therein will be repeated here for corresponding parts. Thus, for example, the housing case in Krueger '394 corresponds to the housing case herein and both parts are referred to using reference numeral 48. Two such corresponding parts are visible in FIG. 1. These are the head 164 of the lock cylinder body and the plug assembly 172 which rotates inside the lock cylinder body. The lock cylinder body is fixed to the tray 13. Parts unique to the present invention carry reference numerals 210 and higher.

Turning now to FIGS. 2 and 3, the rotary actuator of the present invention is shown at 10, mounted on the lock cylinder body 162. A tightening nut (not shown) may be used to fix the lock cylinder body 162 to the tray 13 and gaskets may be included in that connection if desired. A cylindrical nut 210 engages the external threads of the lock cylinder body 162. The cylindrical nut 210 is rotatably mounted on the end of a swage hub 212 (FIG. 3). A portion of the swage hub is surrounded by a C-shaped cam spacer ring 214. Adjacent the cam spacer ring and mounted for rotation about the swage hub is an external cam 216. The swage hub 212 is fixedly mounted on a mounting adaptor plate 218. The adaptor plate 218 in turn is fastened to a base plate 220. The base plate replaces the mounting adaptor 92 of the Krueger '394 patent. The remaining portions of the actuator shown in FIGS. 2 and 3, including the housing case 48 and the housing cover 74 are largely the same as in Krueger '394.

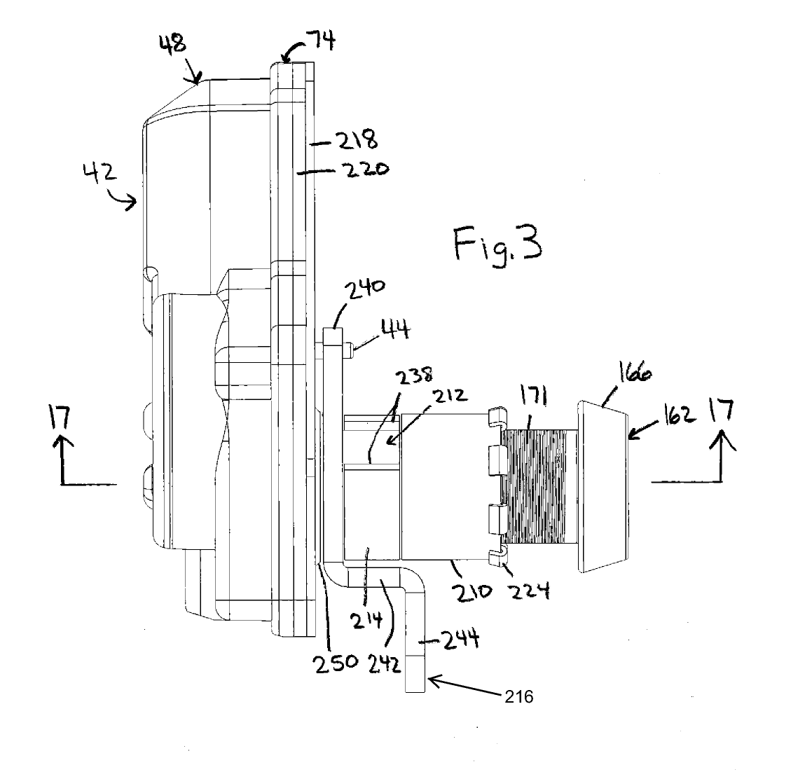

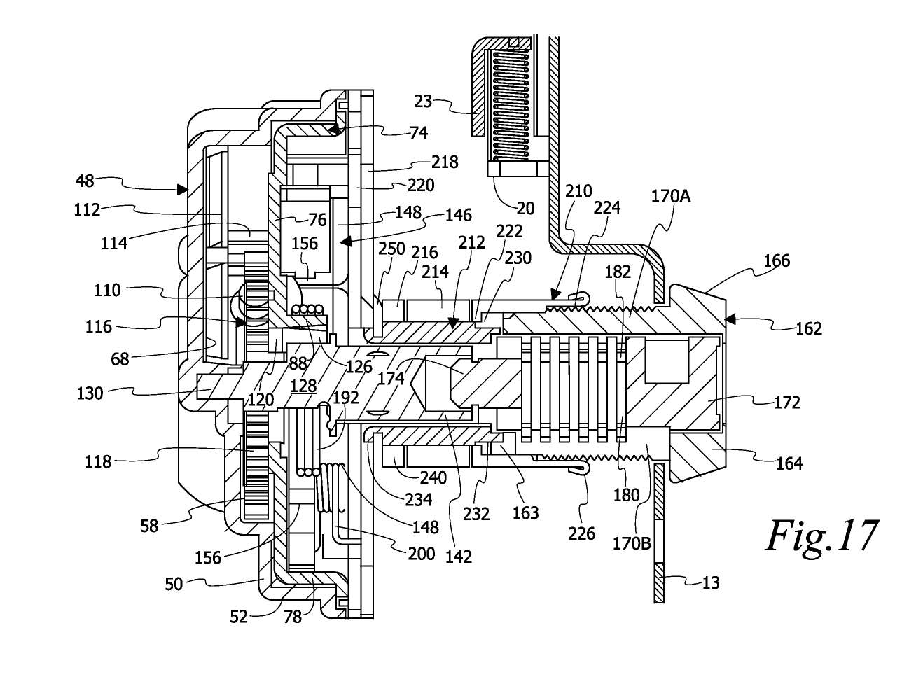

Details of the lock structure, including the lock cylinder body and the plug assembly are shown in FIGS. 4 and 17. The hollow lock cylinder body 162 is a generally hollow cylindrical member. A lug 163 protrudes from its inner end. The body includes a head 164 which has a beveled exterior surface 166. A gasket may be placed under the head. The head may be integrally formed with the body or otherwise connected thereto. External threads 171 are formed on the body 162. In this embodiment the body has three openings or channels, two of which are shown at 170A, 170B. The axes of the channels 170A, 170B are spaced 180° from one another. The third channel 170C is midway between the other two, i.e., it is 90° from each channel 170A, 170B. The channels are sized to accept the lock tumblers, as explained below. Mounted for rotation inside the body 162 is a plug assembly 172. The interior end of the plug 172 carries a stubshaft 174. Extending radially from the stubshaft is a stud (not shown). As seen in FIG. 17 the stubshaft 174 fits into the collar 142 of the key lock adaptor shaft 128. The stud fits into a notch in collar 142 to rotationally lock the plug assembly 172 to the key lock adaptor shaft 128. Thus, the key lock adaptor shaft 128 rotates with the plug assembly 172. The plug further defines a longitudinal slot 178 (best seen in FIG. 1) that receives a key (not shown). A series of transverse pockets 180 are also cut into the plug. In this embodiment there are six transverse pockets, although a different number could be used. A tumbler 182 and spring (not shown) are inserted into each transverse pocket 180.

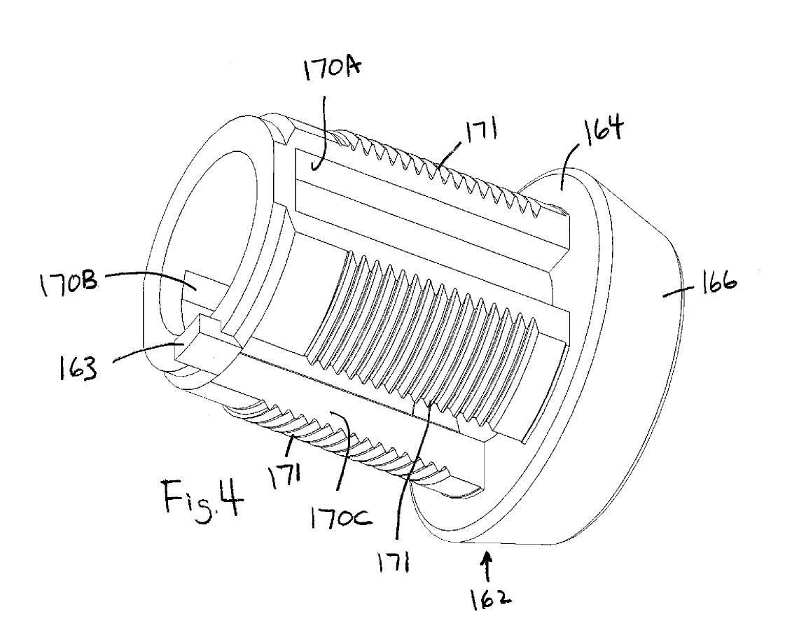

FIGS. 5 and 17 illustrate the cylindrical nut 210. The nut is an annular sleeve having a flange 222 at one end that extends radially inwardly. At the other end the nut has internal threads 224 which are engageable with the external threads 171 of the lock cylinder body. The threaded end of the nut 210 also has a plurality of turned over tabs 226. The tabs assist a wrench or other suitable tool in engaging the nut 210 and tightening it on the lock cylinder body 162.

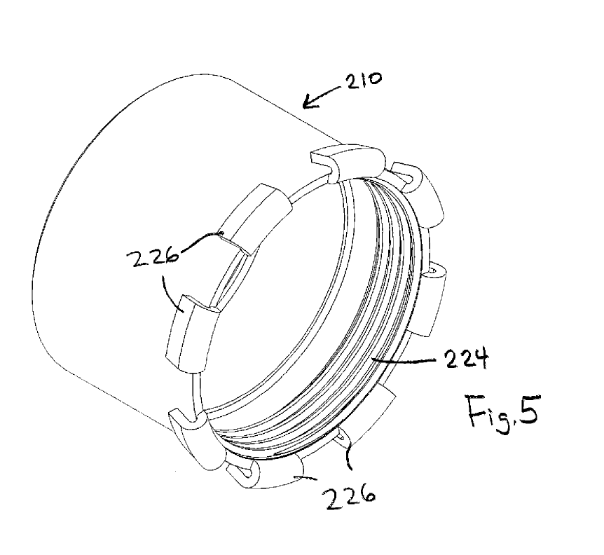

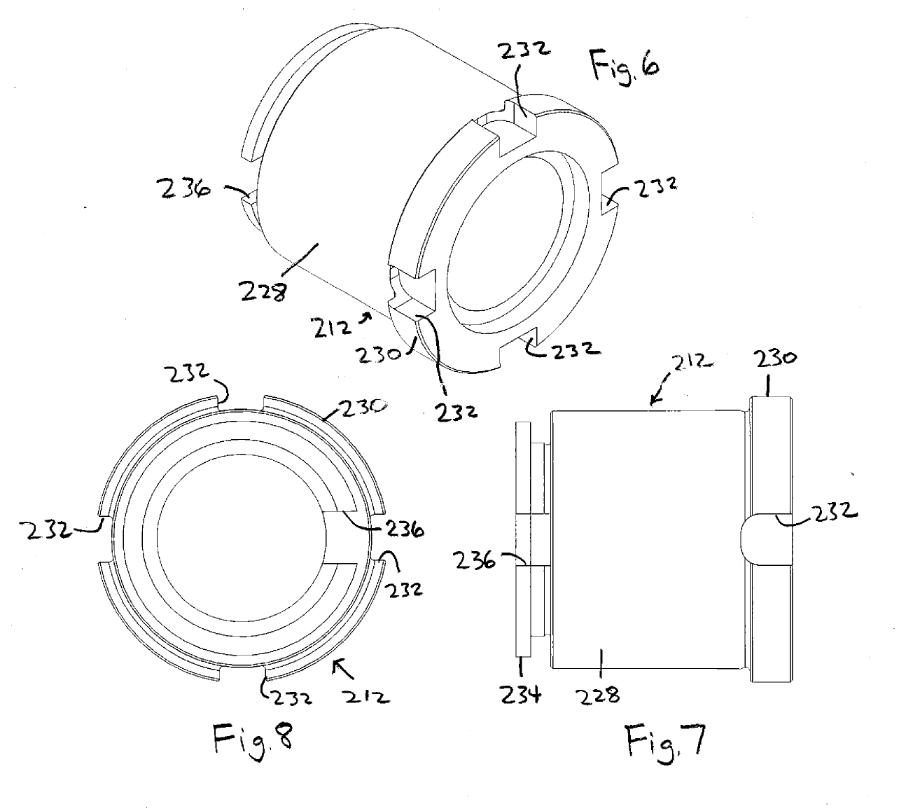

FIGS. 6-8 show the swage hub 212. It has a hollow sleeve 228 with a radially outwardly extending flange 230 on the right end. Four cutouts 232 are formed in the flange 230. One of the cutouts 232 receives the lug 163 on the lock cylinder body 162 to rotationally lock the body 162 to the swage hub 212. On the end of the hub opposite flange 230 is a necked down portion connected to a swage ring 234. The ring 234 has a single cutout 236. This cutout joins a peg on the mounting adaptor plate as will be described below.

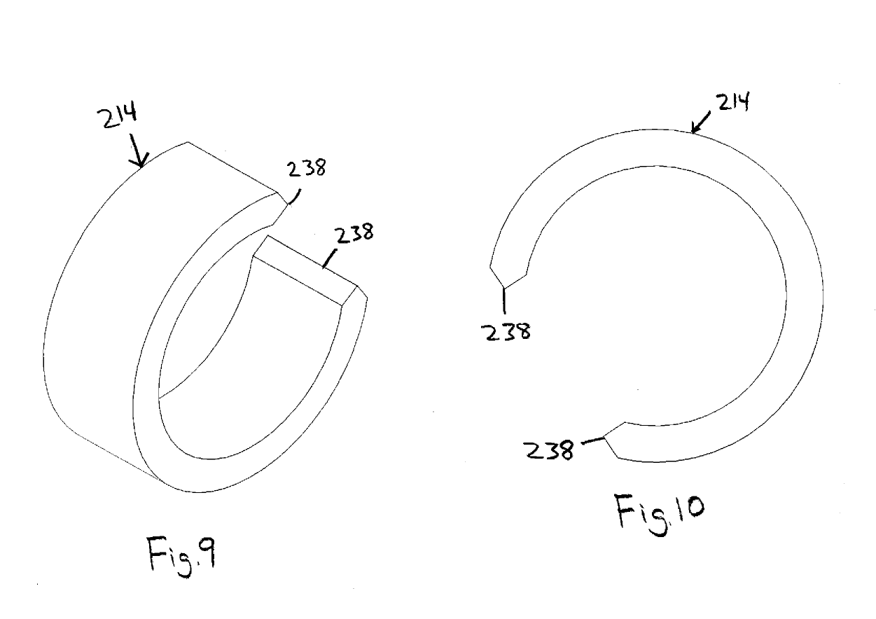

FIGS. 9 and 10 illustrate the C-shaped cam spacer ring 214. It is a partial cylindrical sleeve with a hiatus at edges 238. As seen in FIG. 17, the cam spacer ring sits between the nut 210 and the external cam 216 to hold the axial position of the external cam on the swage hub 212.

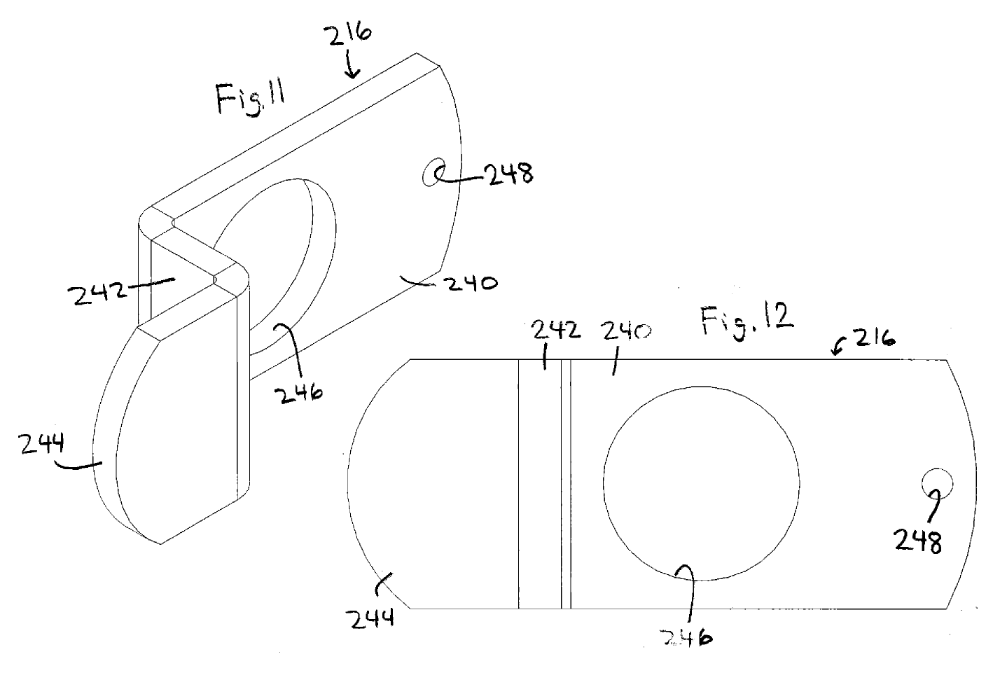

FIGS. 11 and 12 show details of the external cam 216. It is a plate with two simple bends that form a main section 240, and offset 242 and a nose 244. A hole 246 in the main section is sized to allow the external cam to fit around the swage hub 212. A bore 248 in the main section 240 receives the capstan 44 of the actuator's output cam 146. The offset 242 aligns the nose 244 with the lock slide 20 of the handle and lock mechanism 12. Rotation of the external cam 216 causes the lock slide 20 to move in and out of the lock slide openings 19, thereby locking and unlocking the mechanism 12 as described above.

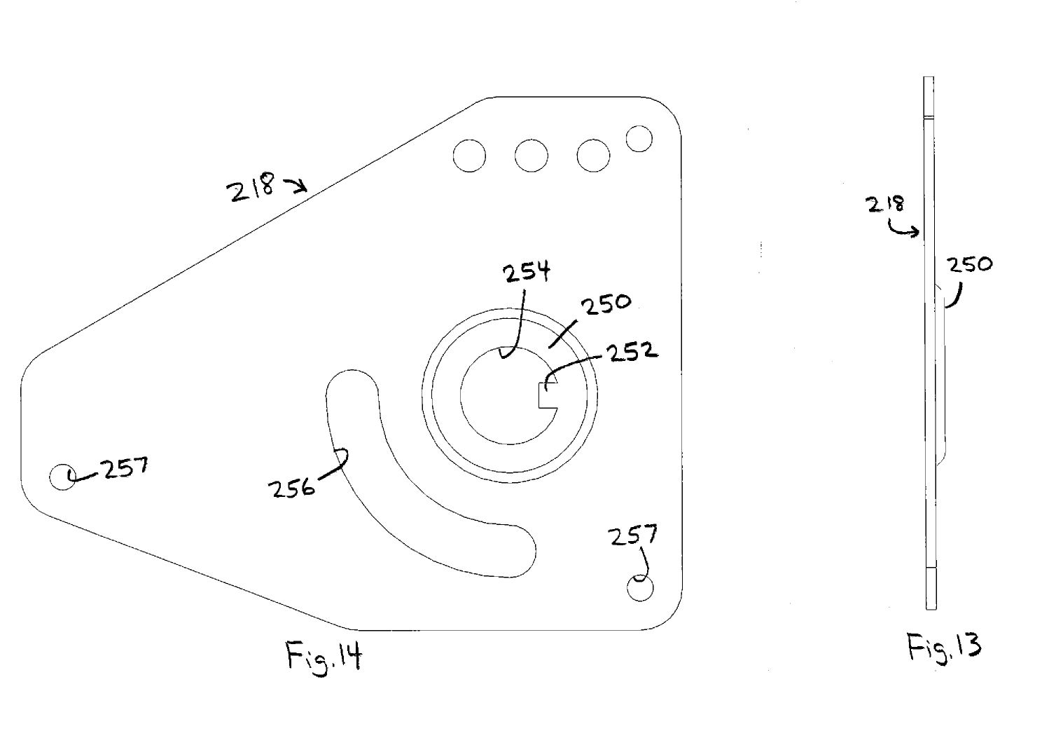

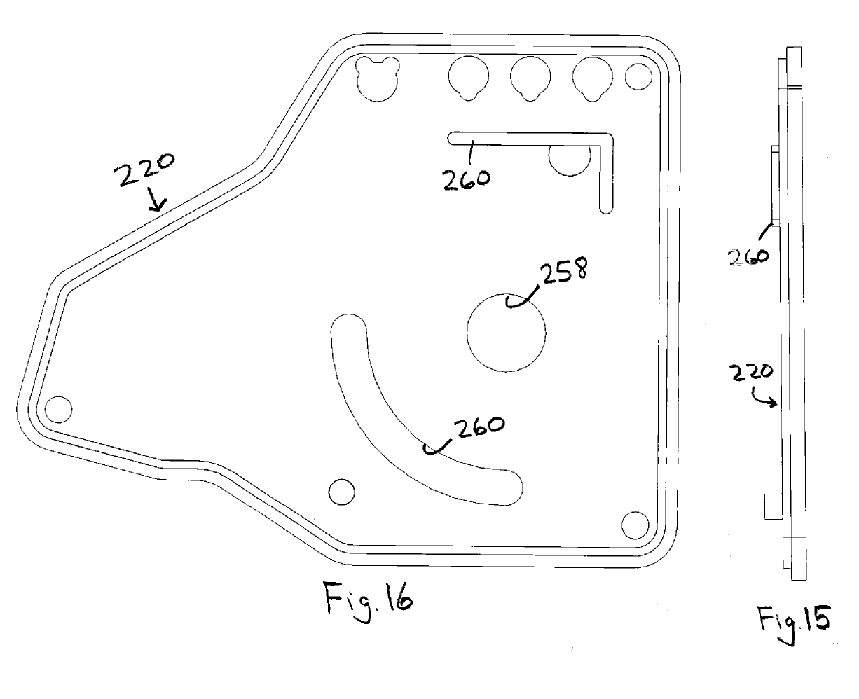

FIGS. 13 and 14 illustrate the mounting adaptor plate 218. It is a roughly trapezoidal-shaped plate having a circular embossment 250 upraised from the plane of the remainder of the plate. Extending radially inwardly from one edge of the embossment is a peg 252. This peg engages the cutout 236 of the swage hub to rotationally lock the hub and adaptor plate 218 together. A central opening 254 through the embossment permits the swage ring 234 to extend through the embossment where the ring is swaged to fix the swage hub 212 to the adaptor plate 218. The opening 254 is large enough to permit passage of the key lock adaptor 128. The adaptor plate also has an arcuate slot 256 through it that permits passage of the capstan 44. Holes 257 are provided for bolts or the like that hold the housing components together.

Turning now to FIGS. 15 and 16, details of the base plate 220 are shown. This plate closes the right side of the housing cover 74. Base plate 220 has a central opening 258 which receives the key lock adaptor 128. An arcuate slot 260 aligns with slot 256 to permit passage of the capstan 44. An L-shaped wall 262 assists in locating the electronic control unit.

FIG. 17 further illustrates how the above-described components fit together. As noted above the cylindrical nut 210 is threaded onto the lock cylinder body 162. Flange 222 of the nut 210 engages the flange 230 on the swage hub 212 to pull the swage hub into abutting relation with the lock cylinder body. The peg 163 and cutout 236 on the swage hub rotationally lock the lock cylinder body and swage hub. It can also be seen that the swaging of swage hub 212 to the mounting adaptor plate 218 fixes the entire actuator housing 42 to the lock cylinder body 162 through the swage hub 212 and cylindrical nut 210. This means there is no interaction between the actuator housing and any other part of the locking device, including the tray 13. Since most locking devices will have a lock cylinder body, attaching the actuator to the lock cylinder body results in no adaptation being needed to convert a purely mechanical lock to one that can have manual and powered actuation.

The overall structure of the actuator assembly 10 is shown in FIGS. 2 and 3. The assembly includes a housing 42 including a case, a cover and a base plate. A capstan 44 protrudes through the arcuate slots 256 and 260 in the housing and adaptor plate.

FIG. 17 illustrates some details of the housing case 48. The case has a floor 50 with an upstanding wall 52 around its perimeter. The floor has a first sloped wall which defines an upper gear well 58 and a lower gear well 68. The housing cover 74 fits on top of the case 48. The cover has a plate 76 with an upstanding wall 78 around its perimeter. Plate 76 includes a spring retainer wall 88 that has an arcuate shape.

The powered drive train inside the housing includes a motor (not shown) and a first gear 110. In the illustrated embodiment this is a bevel gear that meshes with the beveled teeth on the perimeter of a second gear 112. The second gear fits in the lower gear well 68. A third gear 114 in the form of a pinion is integrally formed on, or otherwise affixed to, the center of the second gear 112. The third gear or pinion 114 meshes with a powered drive member in the form of an output gear 116. The output gear fits in the case's upper gear well 58. The upper surface of the output gear carries an upraised hub 120. The hub surrounds an opening that extends fully through the output gear. A keyway adjoins the opening and also extends fully through the output gear. Upstanding from the hub 120 is an arcuate drive wall 126.

There is a manual drive system in the form of a key lock adaptor shaft 128 which has a post 130 at the left end. The first and second drive surfaces of both the output gear 116 and the key lock adaptor shaft 128 are engageable with an actuating member. In this embodiment the actuating member is in the form of an output cam 146, although various forms of the actuating member are possible as the particular application demands. Engagement between the key lock adaptor shaft 128 and the output cam in this embodiment is via a pair of drive fingers as described in Krueger '394. The output cam has a plate 148. The capstan 44 is integrally formed in the plate 148. Alternately, the capstan could be a separate piece fixed to the plate. On the underside of the plate 148 there is a depending ring 156. Also on the underside of the plate 148 is a U-shaped drive pin.

The remaining components of the actuator assembly are a return spring and a bi-stable spring. The return spring is shown schematically at 192. It has a plurality of coils 194 wound in a circle. The bi-stable spring is shown at 200 in FIG. 17.

Full details of how the actuator operates are provided in the Krueger '394 patent. What is provided in the present invention is the ability to adapt any two state (e.g Locked and Unlocked) key-only mechanism (e.g. access control handle) to provide either/or Key/Electric two state (e.g. Lock/Unlock) capability. Rather than altering the handle to provide means for mounting an electric motor and gear train, this invention mounts the electric actuation means, and means to allow the output member that acts to change the access state of the handle, in a single housing, directly to a lock cylinder body. Shown is a means that facilitates attachment using the same threads that are used to mount the lock cylinder to a panel. There is also provided a feature in the housing to constrain the housing rotationally with respect to an existing feature on the lock cylinder body.

It will be appreciated that various modifications and changes may be made to the above described preferred embodiment of a locking device having a manual and powered actuator without departing from the scope of the following claims. For example, while a threaded connection of the cylindrical nut to the lock cylinder body is shown, other connections between these two parts could be used. Indeed, other techniques for connecting the actuator housing to the lock cylinder body could be used. An arrangement that clamps on to the lock cylinder body is one example. Similarly, the housing could be connected to the swage hub by a technique other than swaging. That is, the hub 212 need not be limited to a swage hub. A bolted connection between the hub 212 and the adaptor plate 218 could be used. A welded connection could also be used. Those skilled in the art will appreciate that other types of connections between the hub and adaptor plate are possible. Accordingly, while the term “swage hub” is used to describe the embodiment shown, the hub need not be limited to a swage hub. Furthermore, the attachment of the housing 42 to the lock cylinder body does not have to be made using two parts, the hub and the nut. While the hub and nut construction is advantageous for allowing the nut to be rotatably threaded on to the threads of the lock cylinder body while the housing and hub remain stationary, other constructions for attachment of the housing to the lock cylinder body are possible. For example, where the housing is clamped to the lock cylinder body, the clamping piece could replace the hub and nut with a single clamping member attached to the housing and releasably connectable to the lock cylinder body.

I claim:

1. An actuator assembly for manual or powered actuation of a lock mechanism of the type having a lock cylinder body, the actuator assembly comprising:
a housing for mounting a motor and a powered drive train engaged with the motor; and
a connector having a first portion fixed to the housing and a second portion releasably connectable to the lock cylinder body.

2. The actuator assembly of claim 1 wherein the first portion of the connector is a hub.

3. The actuator assembly of claim 2 wherein the hub is swaged to the housing.

4. The actuator assembly of claim 1 wherein the second portion of the connector is a nut threadably connectable to the lock cylinder body.

5. The actuator assembly of claim 1 wherein the first portion of the connector is a hub and the second portion of the connector is a nut threadably connectable to the lock cylinder body.

6. The actuator assembly of claim 5 wherein the hub and nut each having a flange that interlocks the flange of the other to prevent axial separation of the hub and nut.

7. The actuator assembly of claim 1 wherein the housing includes an adaptor plate to which the connector is fixed.

8. The actuator assembly of claim 7 wherein the first portion of the connector is a hub which is fixed to the adaptor plate by swaging the hub to the adaptor plate.

9. The actuator assembly of claim 1 wherein the second portion of the connector is a nut threadably connectable to the lock cylinder body and wherein the nut has a plurality of turned over tabs on its exterior surface.

10. A method of converting a manually-operable lock mechanism of the type having a lock cylinder body to manual or powered actuation thereof, comprising the steps of:
providing a housing for mounting a motor and a powered drive train engaged with the motor; and
mounting the housing on the lock cylinder body with the powered drive train in operating engagement with the lock mechanism.
